(19) United States
(12) Patent Application Publication
(10) Pub. No.: US 2011/0121967 A1
(43) Pub. Date: May 26, 2011

(54) Tamper-proof security system component

(75) Inventors: Faycal Benjelloun, Great Neck, NY (US); Michael C. Devine, Blue Point, NY (US); George N. Wilson, Maspeth, NY (US)

(73) Assignee: Honeywell International Inc., Morristown, NJ (US)

(21) Appl. No.: 11/788,564

(22) Filed: Apr. 19, 2007

Related U.S. Application Data
(60) Provisional application No. 60/794,232, filed on Apr. 21, 2006.

(51) Int. Cl. G08B 21/00

(52) U.S. Cl. 340/540

(57) ABSTRACT

A tamper-proof security system component allowing a security device with a tamper detection switch to be mounted on an irregular surface. The component includes a rear housing portion, which is mounted on a surface and its actuating surface adjusted, and a front housing portion affixed to the rear housing portion, which contains a security device such as a key pad. When the front housing portion is mated to the rear housing portion by an installer, a tamper detection switch which protrudes from the front housing portion is aligned with the actuating surface in the rear housing portion. In order to adjust the actuating surface, the actuating surface is located on a pivotal arm with a threaded aperture and a set screw disposed within the threaded aperture is turned causing the pivotal arm to move and the location of the actuating surface to be optimized.

### TECHNICAL FIELD

This invention relates to tamper switches used for detecting if a security system device is removed from an installation without authorization, such as when a security system keypad or motion detector is forcibly removed from a wall by an intruder.

### BACKGROUND ART

Devices in security systems and the like are often provided with self-contained tamper switches. The tamper switch, which is preferably within the device housing and thus not readily visible, will function to generate an alarm signal if the housing is removed from the installation in an unauthorized manner. For example, a tamper switch embedded in a security system keypad housing will cause an alarm to be generated if an intruder forcibly removes the keypad housing from the wall in an attempt to disable the alarm system.

Typically, the tamper switch is in the form of a plunger switch that is compressed to the closed position when the housing is installed against the wall. Thus, if the housing is removed from the wall, the plunger switch would open and the processing circuitry within the keypad device would generate the alarm signal and send the signal to the control panel for processing.

This prior art design depends on the wall, against which the housing is installed, to be flat. Problems arise when the mounting surface is not flat; i.e. when it has surface irregularities such as bumps or recesses. When this happens, the tamper switch operation is compromised since it may not rest in the optimal position for closing the plunger switch. In addition, during the installation process, the mounting of the keypad or other security device on an irregular surface causes the installer extra work in adjusting the plunger or tamper detection switch.

It is therefore an object of the present invention to provide a device and method for more reliable tamper detection.

It is a further object of the present invention to provide a device and method for installation ease of security devices with tamper detection switches.

### DISCLOSURE OF THE INVENTION

The present invention is a tamper-proof security system component which allows a security device with a tamper detection switch to be mounted on an irregular surface and which increases tamper detection reliability. The tamper-proof security system component includes a rear housing portion and a front housing portion. The rear housing portion is mounted on a surface and adjusted for tamper detection reliability as described below. The front housing portion, which contains a security device such as a key pad or motion detector, is affixed to the rear housing portion. When the front housing portion is mated to the rear housing portion by the installer, a tamper detection switch which protrudes from the front housing portion is aligned with an actuating surface in the rear housing portion. The tamper detection switch or plunger which is on the rear side of the security device's circuit board is urged from its biased or first position of being open or extended to its closed or second position of being compressed. One skilled in the art will recognize that open and closed are terms that may be interchanged and that when the plunger is extended it may be considered open and when it is compressed it may be considered closed, and vice versa.

To increase tamper detection reliability and allow mounting of the security device on an irregular surface, the actuating surface in the rear housing portion is adjusted for optimum compression of the tamper detection switch. In order to accomplish this, the actuating surface in the rear housing portion is located on a pivotal arm that has a threaded aperture. The pivotal arm is attached to the rear housing portion by a pivot rod which may be integral to the rear housing portion. In order to adjust the pivotal arm and optimize the actuating surface, a set screw disposed within the threaded aperture of the pivotal arm is turned. The set screw has a substantially flat end which, after a number of turns, presses against the mounting surface on which the rear housing portion is mounted. Because the flat end of the screw abuts against the mounting surface, the pivotal arm is pulled towards the set screw head causing the pivotal arm to move into an actuation position and the location of the actuating surface to be optimized.

The tamper-proof security system component includes a stop within the rear housing portion in a position that limits the distance the pivotal arm can pivot. This keeps the installer from turning the set screw too far and causing damage to the tamper detection switch. Additionally, the actuating surface is substantially flat so that the tamper detection switch is compressed uniformly, increasing the reliability of the tamper detection switch. The uniform compression from the actuating surface on the tamper detection switch causes the security device to generate a tamper signal that signifies the tamper detection switch is closed. When the security device is tampered with and the actuating surface does not compress the tamper detection switch, the tamper detection switch is extended due to the biasing component (e.g. a spring) and generates a corresponding tamper signal which triggers the security device to transmit a tamper detect signal to the security system.

The present invention is also a method of installing a tamper-proof security system component comprising the steps of mounting a rear housing portion on a surface wherein the rear housing portion contains a pivotally attached pivotal arm as described above, then turning a set screw to pivot or adjust the pivotal arm into an actuating position. Then a front housing portion is mated to the rear housing portion so that the actuating surface on the pivotal arm can urge the tamper detection switch into a second or closed position as described above. The method includes detecting by the tamper detection switch when the tamper detection switch is no longer urged into a closed or second position. The method also includes the step of transmitting by the security device a tamper detection signal to a security system when the tamper detection switch is no longer urged into the second position.

### BRIEF DESCRIPTION OF THE DRAWING

FIG. 1 is a cross-section view of a preferred embodiment of the present invention prior to installation.

FIG. 2 is a more detailed cross-section view of the rear housing portion.

FIG. 3 is a cross-section view of the rear housing portion and the front housing portion after installation.

FIGS. 4a and 4b are front and rear perspective views of the pivotal arm of the preferred embodiment of the present invention.

### BEST MODE FOR CARRYING OUT THE INVENTION

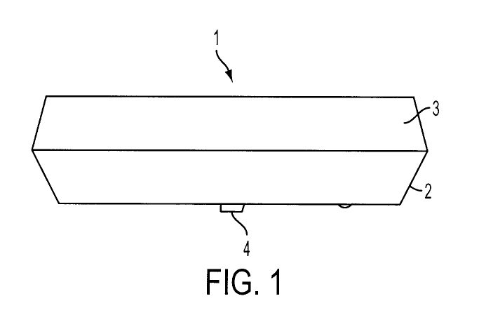

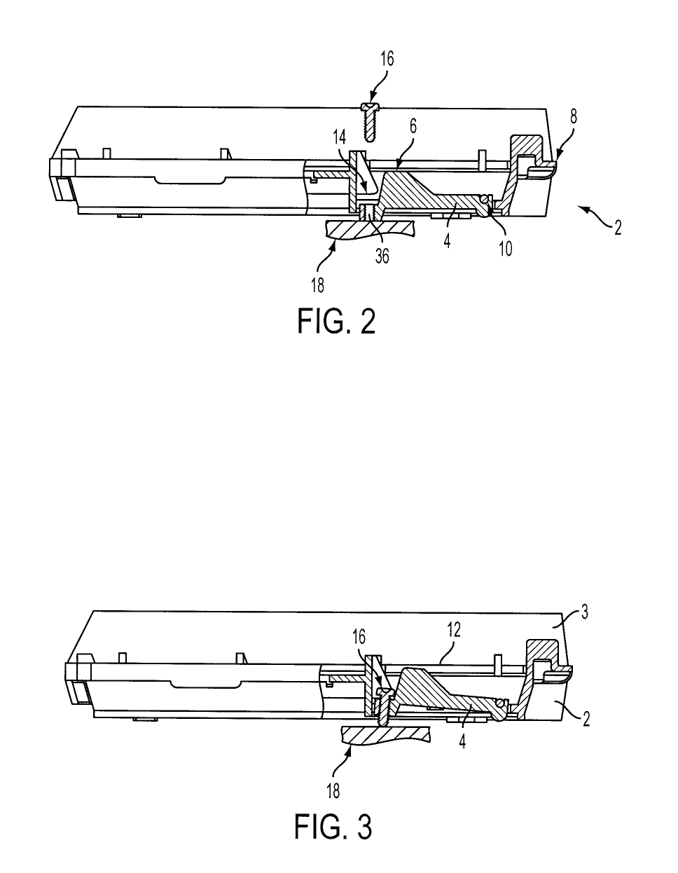

The preferred embodiments of the present invention will now be described with respect to the Figures. FIG. 1 illustrates a cross section of a tamper proof security system component 1 which includes a rear housing portion 2, a front housing portion 3 and a pivotal arm 4 in a non-engaged position. The front housing portion 3 contains a security device such as a key pad, a motion detector, a passive infrared detector, or a siren. The rear housing portion 2 is shown in further detail in FIG. 2. The pivotal arm 4 has an actuating surface 6. In the final installation position, the pivotal arm 4 should rest against a stop 14. During installation, the installer will place the rear housing portion 2 in the desired location with respect to the mounting surface 18, which is typically a wall. A set screw 16 will be placed through an opening in the stop 14 and then threaded into the mating aperture 36 of the pivotal arm 4 as shown in FIGS. 2 and 3. The installer then turns the screw so it travels through the threaded aperture 36 of the pivotal arm 4 and makes contact with the mounting surface 18. At this point, further turning of the screw 16 will cause the pivotal arm 4 to travel away from the mounting surface 18 and towards the stop 14, until it reaches the stop 14 as shown in FIG. 3. The installer will sense an increased resistance in turning the screw and will then realize that the pivotal arm 4 is in the appropriate position and stop turning the screw. FIG. 3 shows the pivotal arm 4 in its actuating or engaged position. It also shows the rear housing portion mated with the front housing portion and the actuating surface 6 compressing the tamper detection or plunger switch (not shown) on the PC board 12 of the security device. This places the tamper detection switch in the desired closed or second position. If the tamper-proof security system component 1 is pulled from the mounting surface 18 the tamper detection switch will move into an open or first position because the tamper detection switch is biased by a spring or other means into that position. When this happens the security device in the front housing portion 3 will transmit a tamper detect signal to the security system (not shown) as known in the art.

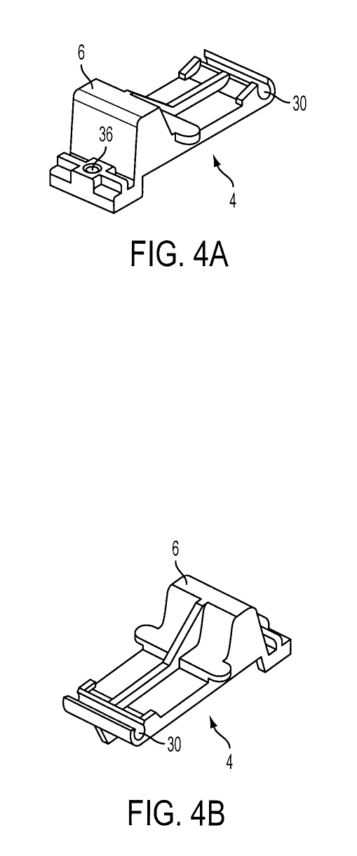

The pivotal arm 4 is also shown in perspective views in FIGS. 4a and 4b. The pivotal arm 4 has a U-shaped recess 30 that extends across the pivotal arm 4, which when assembled with the rear housing portion 2, will allow insertion onto a pivot rod 10 on the rear housing portion 2. As assembled, the pivot arm 4 may freely pivot about the pivot rod 10 to allow optimal placement during installation. As can be seen, any variances in the space between the housing and the mounting surface will be overcome by simply turning the screw the appropriate number of times until the pivotal arm 4 is caused to contact the stop 14 as shown in FIG. 3. Thus, unevenness in the mounting surface, whether caused by bumps or recesses, will not affect the ability to cause the pivotal arm 4 to rest in the desired final location as shown in FIG. 3.

It will be apparent to those skilled in the art that modifications to the specific embodiment described herein may be made while still being within the spirit and scope of the present invention. For example, the actuating surface 6 may be a conical shape or a different shape that causes the actuating surface 6 to compress the tamper detection switch. The pivotal arm 4 may be shaped differently and may pivot differently than as described above. Also the stop 14 may be located in a different place.

What is claimed is:

1. A tamper-proof security system component comprising:
a. a rear housing portion comprising:
i. a pivotal arm comprising an actuating surface and a threaded aperture, wherein said pivotal arm is pivotally attached to said rear housing, and
ii. a set screw disposed within the threaded aperture,
b. a front housing portion comprising a security device, wherein said security device comprises a tamper detection switch with biasing means for urging said tamper detection switch into a first position;
wherein when said set screw is turned it causes said pivotal arm to pivot into an actuating position, and when said front housing portion is mated with said rear housing portion said actuating surface urges said tamper detection switch into a second position for a tamper detection mode.

2. The tamper-proof security system component of claim 1 further comprising a stop within the rear housing portion in a position that limits the distance said pivotal arm can pivot.

3. The tamper-proof security system component of claim 1 wherein said actuating surface is a substantially flat surface.

4. The tamper-proof security system component of claim 1 further comprising a pivot rod that allows said pivotal arm to pivot.

5. The tamper-proof security system component of claim 1 wherein said tamper detection switch generates a tamper signal that signifies when said actuating surface is no longer urged into the second position.

6. The tamper-proof security system component of claim 1 wherein said security device transmits a tamper signal to a security system when said actuating surface is no longer urged into the second position.

7. The tamper-proof security system component of claim 1 wherein said security device comprises a keypad.

8. The tamper-proof security system component of claim 1 wherein said security device comprises a passive infrared detector.

9. The tamper-proof security system component of claim 1 wherein said security device comprises a motion detector.

10. The tamper-proof security system component of claim 1 wherein said security device comprises a siren.

11. A method of installing a tamper-proof security system component comprising the steps of:
a. mounting a rear housing portion on a surface, said rear housing portion comprising a pivotally attached pivotal arm comprising an actuating surface and threaded aperture,
b. turning a set screw disposed within said threaded aperture causing said pivotal arm to pivot into an actuating position, and
c. mating a front housing portion to said rear housing portion, said front housing portion comprising a security device comprising a tamper detection switch with biasing means for urging said tamper detection switch into a first position,
whereby said actuating surface urges said tamper detection switch into a second position for a tamper detection mode.

12. The method of claim 11 wherein said actuation position is determined when said pivotal arm presses against a stop disposed on said rear housing portion.

13. The method of claim 11 further comprising the step of detecting by said tamper detection switch when said tamper detection switch is no longer urged into the second position.

14. The method of claim 11 further comprising the step of transmitting by said security device a tamper detection signal to a security system when said tamper detection switch is no longer urged into the second position.
